(19) United States
(12) Patent Application Publication
(10) Pub. No.: US 2008/0083510 A1
(43) Pub. Date: Apr. 10, 2008

(54) ADJUSTABLE GATE WITH INTERMEDIATE KEEPER

(76) Inventors: Douglas Kerr Gessford, Mount Sterling, KY (US); James Daryl Eason, Lexington, KY (US)

Correspondence Address: KING & SCHICKLI, PLLC, 247 NORTH BROADWAY, LEXINGTON, KY, 40507, US

(21) Appl. No.: 11/867,401

(22) Filed: Oct. 4, 2007

Related U.S. Application Data
(60) Provisional application No. 60/849,303, filed on Oct. 4, 2006.

(51) Int. Cl. E06B 9/15

(52) U.S. Cl. 160/161

(57) ABSTRACT

An apparatus temporarily occupies a walkway created by two sides and a floor in a secure and stable fashion. The apparatus includes a gate for attaching to the two sides and having a depending portion intermediate the sides. A keeper mounted to the floor includes an opening for removably receiving the depending portion of the gate. The depending portion in the keeper helps retain the gate in the walkway in a secure and stable, yet removable fashion, and with enhanced resistance to bending inwardly and outwardly relative to the sides if pushed or pulled.

This application claims the benefit of U.S. Provisional Patent Application Ser. No. 60/849,303, filed Oct. 4, 2006, the disclosure of which is expressly incorporated herein by reference.

### TECHNICAL FIELD

The present invention relates generally to structures for temporarily occupying an opening and, in particular, to a gate with an intermediate keeper for stabilizing the mid-section when expanded in the opening.

### BACKGROUND OF THE INVENTION

Gates for temporary positioning in a walkway to prevent children and animals from passing are well known in the art. One example is the adjustable, accordian-style gate shown in U.S. Pat. No. 4,669,521 to Barnes, the disclosure of which is incorporated herein by reference. Advantageously, this particular type of gate when expanded in the opening can be withdrawn in two different manners, either by compressing the latticework transversely in the opening, or pivoting relative to a mounting hinge arrangement provided along one side of the opening. Either way, the ability to walk through and reposition the gate in the opening in the desired fashion is achieved with ease.

While this type of gate may be mounted such that the opposed ends are each secured to a stable support structure, such as a wall or post, the flexibility afforded by the elongation of the latticework allows the mid-section of the gate to bend inwardly and outwardly rather freely if pulled. In order to combat this unrestrained movement, the '521 patent to Barnes proposed an intermediate leg support with a rubber foot member for frictionally engaging the adjacent floor when the gate is expanded. Although this arrangement is suited for use in some practical environments, the foot may have difficulty achieving the proper amount of traction on low friction surfaces, such as carpet. Moreover, the frictional engagement eventually results in wear on the foot, which can lessen its ability to provide the desired holding force.

Accordingly, a need is identified for an improved manner of providing a holding force for the mid-section of an expandable gate, intermediate the sides mounted to stable support structures adjacent an opening. The solution should be easy and inexpensive to implement, including in a retrofit situation. Moreover, it should not in any way interfere with the ability to adjust the gate for purposes of walling through the corresponding opening.

### SUMMARY OF THE INVENTION

In accordance with one aspect of the invention, an apparatus for temporarily occupying a walkway created by two sides and a floor is provided. The apparatus comprises a substantially rigid gate for attaching to the two sides for forming an at least temporary barrier to passing freely through the walkway. The gate includes a depending portion intermediate the sides, and a keeper is provided for mounting to the floor. The keeper includes a frame with a top face, a bottom face, and a plurality of sides forming an opening for removably receiving the depending portion of the gate. The depending portion when positioned in the keeper retains the gate in the walkway in a secure and stable, yet removable fashion, and with enhanced resistance to bending inwardly and outwardly relative to the sides if pulled.

Preferably, the gate comprises an accordian-style gate having a latticework body, and the depending portion comprises a support leg movably attached to the gate. Still more preferably, the depending portion comprises an elastomeric foot for positioning in the opening of the keeper, with the height of the opening being substantially equal to or greater than the height of the foot. Most preferably, the opening comprises a slot bounded by the sides of the keeper, with a direction of elongation of the slot in the keeper being generally parallel to a direction of elongation of the gate.

The apparatus may further include means for fastening the keeper to the floor. Preferably, the means for fastening comprises at least two mechanical fasteners, and the keeper further includes passages for receiving the fasteners. Alternatively or in addition, the means for fastening comprises an adhesive.

In one embodiment, leading and trailing sides of the keeper each include a sloping surface. Preferably, the sloping surface forms an angle of less than about 45° with the floor. Still more preferably, opposing sides of the keeper include sloping surfaces.

Another aspect of the invention is a keeper for use with a gate having a direction of elongation for occupying a walkway bounded by two sides and a floor. The keeper includes a body having a slot elongated in a direction transverse to the direction of elongation of the gate. The body has leading and trailing sides having a sloping surface relative to a generally planar bottom surface for contacting the floor. Passages may be provided adjacent the slot for receiving fasteners for attaching the keeper to the floor.

Still another aspect of the invention is a method of using a gate to occupy a walkway bounded by two sides and a floor. The method comprises fastening a keeper having an opening to the floor. The method further comprises inserting a depending portion of the gate in the opening of the keeper attached to the floor.

In one particularly preferred embodiment, the method further includes the step of removing the depending portion from the keeper, such as by lifting the gate. Alternatively, the method may comprise swinging the gate relative to the walkway. In any case, the method may further include returning the depending portion to the opening, such that the gate is held in the desired stable and secure fashion.

### BRIEF DESCRIPTION OF THE DRAWINGS

FIG. 1 is a front elevational view of a gate for temporarily positioning in an opening;

FIG. 1a is an enlarged, partially cutaway view of the gate of FIG. 1;

FIGS. 2a-2f are various views of a keeper for use with a gate of the type shown in FIG. 1; and

FIG. 3 is a front view of the gate and keeper in the operative position.

### DETAILED DESCRIPTION OF THE INVENTION

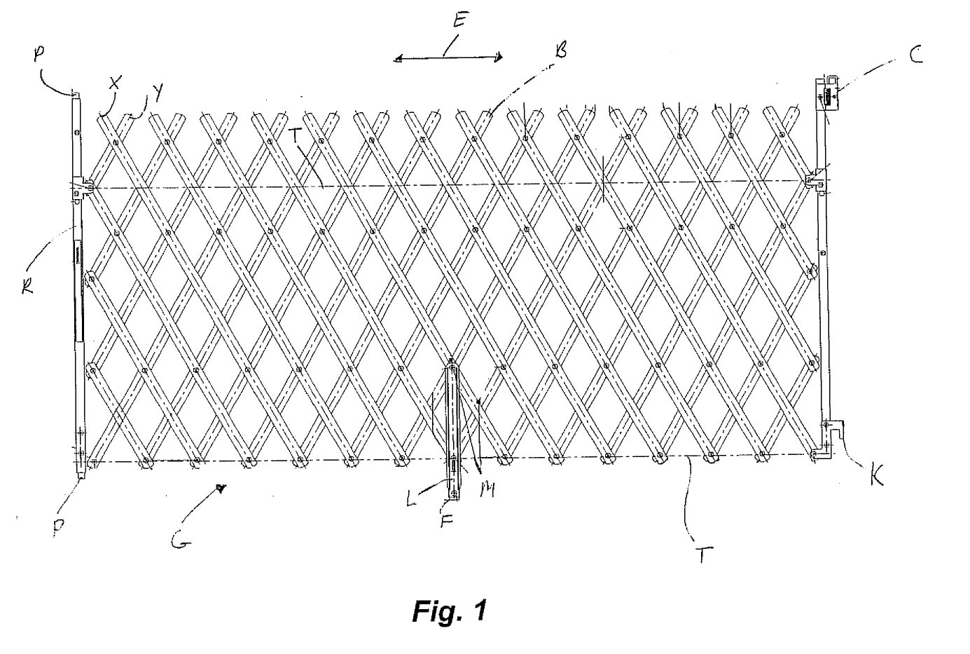

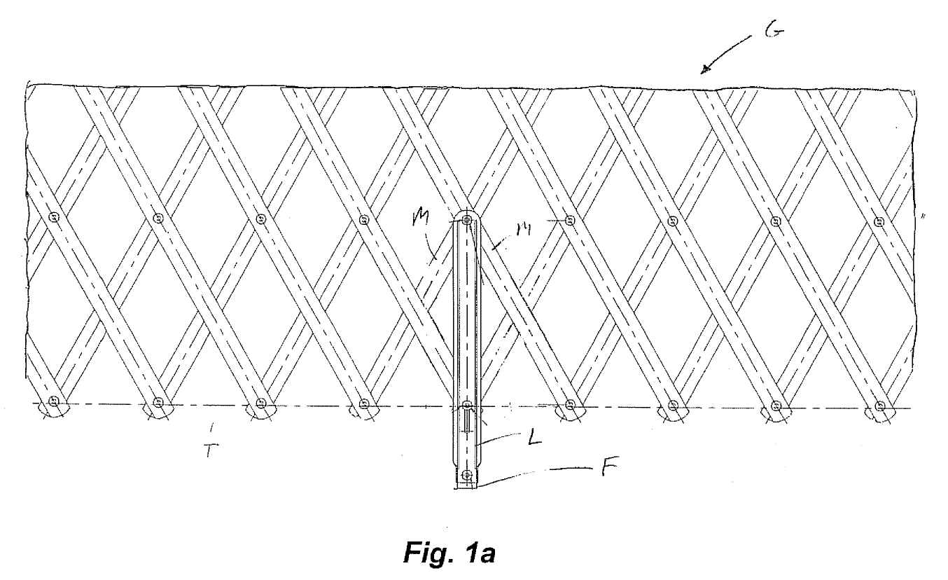

Reference is now made to FIG. 1, which illustrates one possible embodiment of a gate G for use in connection with the disclosed aspects of the invention. In the illustrated embodiment, the gate G is an accordian-style one having a substantially rigid latticework body B (note interconnected members M aligned with axes X and Y) and side rails R, at least one of which is hingedly attached to stable support structure adjacent an opening, such as a doorway, at the top of a flight of stairs, or possibly both. When expanded, the gate G thus occupies the opening, with the opposite side rail R including hardware for removably attaching to the corresponding opposite sidewall such that the blocking provided cannot be easily circumvented by pets or small children. Accordingly, the gate G can be both compressed in the opening or pivoted about the hinge to permit free passage, and then easily returned to the condition occupying the opening.

Although not considered to form an aspect of the invention, an exemplary mounting of the gate G will be described. As shown in FIG. 1, a first side rail R of the gate includes upper and lower pegs P adapted for being received in corresponding holes formed in L-shaped brackets for fastening to a stable support structure, such as a wall or post. The opposite side rail R carries a lower hook K and an upper latch C that individually associate with corresponding structures, such as eye bolts, associated with another stable support structure. By operating the latch C and lifting up on the gate slightly to remove the hook K from the corresponding structure, the gate G may thus be compressed within the opening, as well as swung about the hinged connection thus formed.

With reference to both FIGS. 1 and 1a, the gate G in the illustrated embodiment includes a depending portion in the form of a leg L. As described in detail in the Barnes patent, the leg L may be attached to the gate G adjacent the mid-section by the same rivets that pivotally connect at least two pairs of intermediate members M forming part of the latticework body B. Preferably, the manner of attachment is so as to permit relative movement in the vertical direction, such that as the gate G is expanded and compressed in the transverse direction (note axes T), the leg L lowers and raises, respectively. The leg L also preferably includes a foot F for engaging the floor in the lowered position. As noted above and described in the Barnes patent, this foot F is preferably formed of an elastomer such as rubber to create a high friction engagement when the gate G is in the expanded condition.

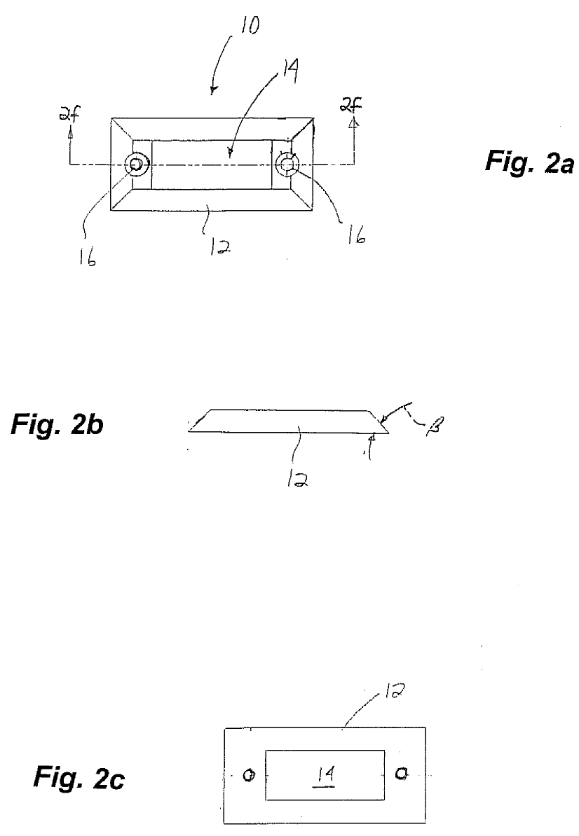

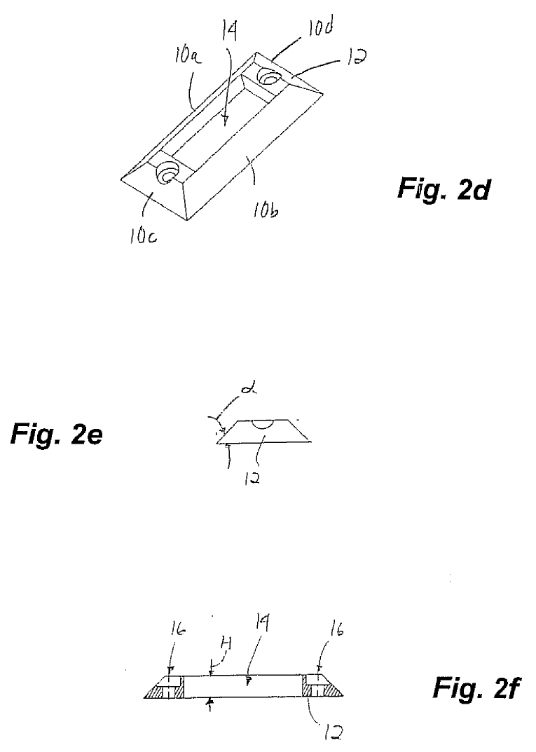

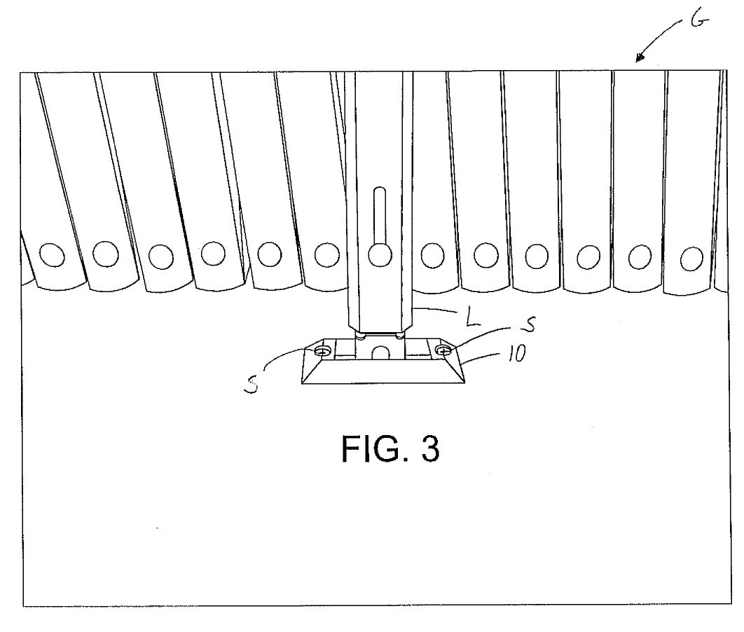

With reference to FIGS. 2a-2f and 3, and in accordance with one aspect of the invention, a keeper 10 is provided for receiving at least part of the depending portion of the gate G, such as leg L and most preferably the foot F. Referring to FIG. 3, the keeper 10 in the most preferred embodiment comprises a body 12 including an oversized opening forming a receiver for receiving the portion of the gate G. The oversized opening preferably takes the form of a slot 14 having a direction of elongation generally parallel to a direction of elongation of the gate G itself (note arrow E in FIG. 1), and the body 12 of the keeper 10 is preferably generally rectangular so as to match the slot. Preferably, the height H of the slot 14 is at least equal to or greater than the corresponding height dimension of the foot F associated with the leg L of the gate G, such that it is occupied in its entirety when positioned therein.

For reasons better understood upon reviewing the description that follows, at least the elongated sides 10a, 10b of the body 10 include surfaces that slope relative to the generally planar bottom surface. Preferably, the slope of the surface of each side 10a, 10b is at an angle of about 45° (see angle α in FIG. 2e). The narrow sides 10c, 10d may also include sloping surfaces, preferably at about the same angle (e.g., about 45°—see angle β in FIG. 2b).

As noted above, the keeper 10 may be attached to the floor in a position for receiving the depending portion or leg L forming part of the gate G in at least the expanded condition. To accomplish this, mechanical fasteners, such as screws S, may be used, in which case the body 12 may include suitable passages 16 adjacent the slot 14 for receiving the screws. Preferably, the passages 16 are countersunk adjacent the upper end (note sectional view in FIG. 2f). This provides a recess for receiving the head end of the corresponding screw or other fastener, and thus prevents it from projecting any substantial distance above an upper surface of the body 12.

With reference now to FIG. 3, one manner of using the keeper 10 in combination with the gate of FIG. 1 is shown. Specifically, once the gate G is mounted in the opening, the keeper 10 is mounted to the floor R adjacent to the normal location where engagement with the foot F would normally occur. This may be estimated by expanding the gate G and making a suitable delible mark on the floor R. Next, the gate G may be removed from the opening, either by way of compression or swinging if hingedly attached, and the keeper 10. The keeper 10 is oriented such that the direction of elongation of the slot 14 is parallel to and generally aligns with the direction of elongation E of the gate C, and is then fastened to the floor (which may in the case of mechanical fasteners (screws S) involve the pre-drilling of pilot holes). Returning the gate G to the position occupying the opening is then accomplished, with the foot F being removably inserted within the slot 14.

As should be appreciated, several advantages arise as a result of the use of the above-described aspects of the present invention. For one, the mid-section of the expanded gate G intermediate the sides is securely held in place against movement in a direction transverse to the direction of elongation E (i.e., pulling or pushing). Consequently, gate stability is enhanced, which is especially important when the gate is positioned at the top of a flight of stairs. However, the ability of the gate G to be withdrawn temporarily from the position occupying the majority of the opening remains uncompromised, since a slight lifting force comparable to that required for unlatching is all that is required to disengage the leg L and/or foot F from the slot 14. Once this is done, the gate G may of course be freely swung to return the opening to the walk-through state. Return of the gate to occupy the opening completed with equal ease and straightforwardness.

A related advantage of the keepers 10 when the opening is in the wall-through state is the relatively low profile. Consequently, the potential for a person's foot contacting the keeper 10 is minimized. The sloped leading and trailing sides 10a, 10b also help to ensure that if contact with a passing foot is made, it is insubstantial and does not impede moving through the opening. The oversized nature of the opening provided by the slot 14 also advantageously ensures that it is relatively easy to position the leg L therein, yet it remains securely held in place.

The following example demonstrates the efficacy of the invention.

### EXAMPLE

A testing jig was constructed in which the sides of the gate were attached in the conventional manner. The gate was then expanded to occupy an opening having a dimension of approximately 50 inches, as proposed in ATSM Standard No. F 1004-04 for pressure mounted gates.

A keeper 10 made of polypropylene was attached to a carpeted floor. Fastening was by way of two #8 by 1½″ wood screws penetrating through openings 16 adjacent the slot 14 in the keeper 10 into the underlying subfloor. The leg L attached to the gate G was inserted into the slot 14 such that all lateral faces of the foot F were substantially surrounded, as shown in FIG. 3, and the end face was adjacent the upper surface of the carpet.

Using a suitable means of attachment and a force gauge, a substantially linear pulling force of greater than 50 pounds was applied to the gate G adjacent the mid-section. The leg L remained securely held in the keeper 10. Upon releasing the force, the gate G immediately returned to the original condition fully occupying and blocking the opening.

The foregoing description of several aspects of the inventions disclosed herein are presented for purposes of illustration and description. The embodiments described are not intended to be exhaustive or to limit the invention to the precise form disclosed. Obvious modifications or variations are possible in light of the above teachings. For example, while the use of mechanical fasteners such as screws is preferable, especially in the case where the floor includes carpet, it is within the broadest aspects to use an adhesive, such as tape or glue, to fasten the keeper 10 in place. Also, the depending portion of the gate G need not be the vertical leg L, but could simply be one or more of the gate members M. The embodiments described were chosen to provide the best illustration of the principles of the invention and its practical application to thereby enable one of ordinary skill in the art to utilize the invention in various embodiments and with various modifications as are suited to the particular use contemplated. All such modifications and variations are within the scope of the invention when interpreted in accordance with the breadth to which it is fairly, legally, and equitably entitled.

1. An apparatus for temporarily occupying a walkway created by two sides and a floor, comprising:
a gate for attaching to the two sides for forming an at least temporary barrier to passing freely through the walkway, said gate having a depending portion intermediate the sides; and
a keeper for mounting to the floor, the keeper having a frame with a top face, a bottom face, and a plurality of sides forming an opening for removably receiving the depending portion of the gate,
whereby positioning the depending portion in the opening of the keeper helps to retain the gate in the walkway in a secure and stable, yet removable fashion, and with enhanced resistance to bending inwardly and outwardly relative to the sides if pulled.

2. The apparatus of claim 1, wherein the gate comprises an accordian-style, expandable gate having a latticework body.

3. The apparatus of claim 1, wherein the depending portion comprises a support leg movably attached to the gate.

4. The apparatus of claim 1, wherein the depending portion comprises an elastomeric foot for positioning in the opening of the keeper, wherein the height of the opening is substantially equal to or greater than the height of the foot.

5. The apparatus of claim 1, wherein the opening comprises a slot bounded by the sides of the keeper.

6. The apparatus of claim 5, wherein a direction of elongation of the slot in the keeper is generally parallel to a direction of elongation of the gate.

7. The apparatus of claim 1, further including means for fastening the keeper to the floor.

8. The apparatus of claim 7, wherein the means for fastening comprises at least two mechanical fasteners, and wherein the keeper further includes passages for receiving the fasteners.

9. The apparatus of claim 7, wherein the means for fastening comprises an adhesive.

10. The apparatus of claim 1, wherein leading and trailing sides of the keeper each include a sloping surface.

11. The apparatus of claim 10, wherein the sloping surface forms an angle of less than about 45° with the floor.

12. The apparatus of claim 10, wherein opposing sides of the keeper include sloping surfaces.

13. In combination with a gate for occupying a walkway created by two sides and a floor, said gate having a depending portion intermediate the sides, the improvement comprising a keeper mounted to the floor, the keeper including an opening for removably receiving the depending portion of the gate while remaining mounted to the floor.

14. A keeper for use with a gate having a direction of elongation for occupying a walkway bounded by two sides and a floor, comprising:
a body including a slot elongated in a direction transverse to the direction of elongation of the gate, said body having leading and trailing sides having a sloping surface relative to a generally planar bottom surface for contacting the floor.

15. The keeper of claim 14, further including passages adjacent the slot for receiving fasteners for attaching the keeper to the floor.

16. A method of using a gate to occupy a walkway bounded by two sides and a floor comprising:
fastening a keeper having an opening to the floor; and
inserting a depending portion of the gate in the opening of the keeper attached to the floor.

17. The method of claim 16, further including the step of removing the depending portion from the keeper without detaching the keeper from the floor.

18. The method of claim 17, wherein the step of removing the depending portion from the keeper comprises lifting the gate.

19. The method of claim 18, further including swinging the gate relative to the walkway.

20. The method of claim 17, further including the step of returning the depending portion to the opening in the keeper.
